(19) United States
(12) Patent Application Publication
(10) Pub. No.: US 2014/0285042 A1
(43) Pub. Date: Sep. 25, 2014

(54) DC ELECTRIC MOTOR HAVING AN INSULATING SLEEVE

(71) Applicant: Johnson Electric S.A., Murten (CH)

(72) Inventors: James Ching Sik LAU, Hong Kong (CN); Tongjie LI, Shenzhen (CN); Guowei SUN, Shenzhen (CN); Qingbin LUO, Shenzhen (CN); Hongwei ZHANG, Shenzhen (CN); Huiting ZHONG, Shenzhen (CN)

(73) Assignee: JOHNSON ELECTRIC S.A., Murten (CH)

(21) Appl. No.: 14/225,318

(22) Filed: Mar. 25, 2014

(30) Foreign Application Priority Data
Mar. 25, 2013 (CN) 201310098562.X

(51) Int. Cl. H02K 1/04; H02K 11/00; H02K 11/02; H02K 1/17

(52) U.S. Cl. CPC H02K 1/04; H02K 1/17; H02K 11/0094; H02K 11/028
USPC 310/72; 310/154.01

(57) ABSTRACT

A DC electric motor (10) comprises a rotor (30) rotably attached to a stator (20). The rotor (30) comprises an output shaft (31) and a rotor core (33), and a plurality of winding coils (35) wound on the rotor core (33) and electrically connected to a commutator (34) on the output shaft (31). An insulating sleeve (32) is disposed between the output shaft (31) and rotor core (33), forming a capacitor between the output shaft (31) and rotor core (33), thereby reducing the EMI caused by the fluctuating current in the winding coils (35).

### CROSS REFERENCE TO RELATED APPLICATION(S)

This application claims the benefit of Chinese patent application Ser. No. 201310098562.X, filed on Mar. 25, 2013. The entire content of the aforementioned patent application is hereby incorporated by reference for all purposes.

### BACKGROUND

Due to safety concerns, current guidelines and regulations for alternating current (AC) electric motors require that an AC electric motor operating at a voltage exceeding a certain value must have an insulating sleeve between the motor output shaft and the rotor core of the motor in order to prevent electrical leakage through the output shaft, wherein the minimum thickness of the sleeve is determined based upon the magnitude of the voltage.

On the other hand, direct current (DC) electric motors are not subjected to similar safety guidelines and regulations. As a result, in order to reduce manufacturing and material costs, DC electric motors typically do not contain an insulating sleeve between the motor output shaft and rotor core.

However, Applicants have found that during the operation of many DC electric motors, frequent changes in the polarity of the motor winding coils will create a high-frequency signal. This high-frequency signal is easily coupled to the motor output shaft, allowing the signal to radiate outside the motor via the output shaft, and creating undesirable electromagnetic interference (EMI).

Accordingly, there exists a need for a DC electric motor with improved EMI characteristics.

### SUMMARY

Some embodiments are directed at a direct current (DC) electric motor, comprising a rotor rotably attached to a stator. The stator comprises an outer shell, a plurality of magnets, and a plurality of brushes. The rotor comprises an output shaft, a rotor core, and a commutator fixed to the output shaft. A plurality of winding coils are wound around the rotor core and electrically connected to the commutator, which is configured to be in sliding contact with the plurality of brushes. An insulating sleeve is disposed between the output shaft and rotor core to reduce the EMI caused by fluctuating current in the winding coils during motor operation. In some embodiments, a first capacitor is formed between the output shaft and rotor core, and a second capacitor is formed between the rotor core and outer shell. In some embodiments, the second capacitor is configured to have a capacitance equal to or greater than that of the first capacitor. In some embodiments, a ratio of the capacitance of the second capacitor and capacitance of the first capacitor is configured to be between 0.1 and 50.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered which are illustrated in the accompanying drawings. These drawings depict only exemplary embodiments and are not therefore to be considered limiting of the scope of the claims.

FIG. 1 illustrates a DC electric motor in accordance with some embodiments.

FIG. 2 illustrates an exploded view of a DC electric motor in accordance with some embodiments.

FIG. 3 illustrates a side cross-sectional view of a DC electric motor in accordance with some embodiments.

FIG. 4 illustrates a top-down cross-sectional view of a DC electric motor in accordance with some embodiments.

FIG. 5 is a schematic diagram illustrating impedances between different components of a DC electric motor in accordance with some embodiments.

### DETAILED DESCRIPTION

Various features are described hereinafter with reference to the figures. It shall be noted that the figures are not drawn to scale, and that the elements of similar structures or functions are represented by like reference numerals throughout the figures. It shall also be noted that the figures are only intended to facilitate the description of the features for illustration and explanation purposes, unless otherwise specifically recited in one or more specific embodiments or claimed in one or more specific claims. The drawings figures and various embodiments described herein are not intended as an exhaustive illustration or description of various other embodiments or as a limitation on the scope of the claims or the scope of some other embodiments that are apparent to one of ordinary skills in the art in view of the embodiments described in the Application. In addition, an illustrated embodiment need not have all the aspects or advantages shown.

An aspect or an advantage described in conjunction with a particular embodiment is not necessarily limited to that embodiment and may be practiced in any other embodiments, even if not so illustrated, or if not explicitly described. Also, reference throughout this specification to “some embodiments” or “other embodiments” means that a particular feature, structure, material, process, or characteristic described in connection with the embodiments is included in at least one embodiment. Thus, the appearances of the phrase “in some embodiments”, “in one or more embodiments”, or “in other embodiments” in various places throughout this specification are not necessarily referring to the same embodiment or embodiments.

Some embodiments are directed at a direct current (DC) electric motor, comprising a rotor rotably attached to a stator. The stator comprises an outer shell, a plurality of magnets, and a plurality of brushes. The rotor comprises an output shaft, a rotor core, and a commutator fixed to the output shaft. A plurality of winding coils are wound around the rotor core and electrically connected to the commutator, which is configured to be in sliding contact with the plurality of brushes. An insulating sleeve is disposed between the output shaft and rotor core to reduce the EMI caused by fluctuating current in the winding coils during motor operation. In some embodiments, a first capacitor is formed between the output shaft and rotor core, and a second capacitor is formed between the rotor core and outer shell. In some embodiments, the second capacitor is configured to have a capacitance equal to or greater than that of the first capacitor. In some embodiments, a ratio of the capacitance of the second capacitor and capacitance of the first capacitor is configured to be between 0.1 and 50.

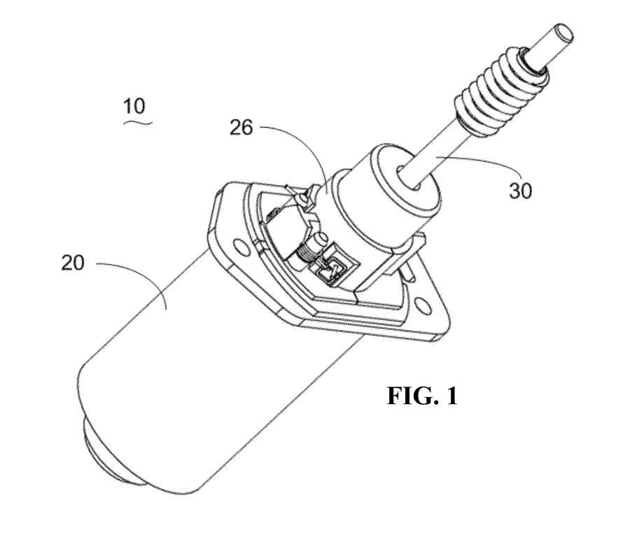

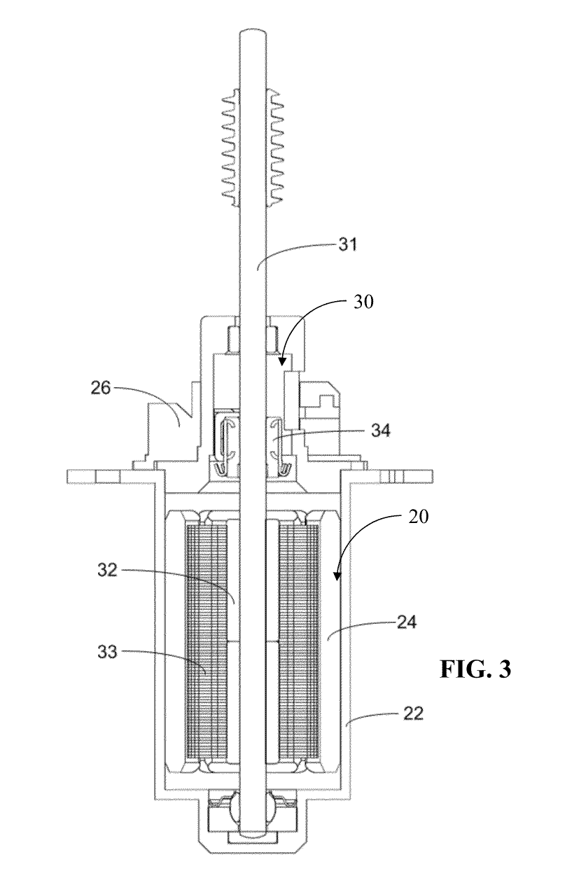

FIGS. 1-4 illustrate a DC electric motor 10 (hereinafter, “motor”) in accordance with some embodiments, comprising a stator 20 and a rotor 30. It is understood that while the illustrated embodiments illustrate a motor 10 having an inner rotor design with rotor 30 accommodated and configured to rotate within stator 20, other configurations may be used in other embodiments, e.g., a motor having an outer rotor design with the stator being accommodated within the rotor.

In some embodiments, stator 20 comprises an outer shell 22 and a plurality of magnets 24 fixed to an inner wall of outer shell 22. Magnets 24 may comprise one or more permanent magnets. However, it is understood that magnets 24 may comprise any type of component capable of generating a magnetic field. In some embodiments, outer shell 22 is substantially cup-shaped or cylindrical in form, and is made of metal. An end cap 26 may be attached to one end of outer shell 22. A plurality of electric brushes 28 may be disposed on end cap 26. In some embodiments, electric brushes 28 are slidably disposed on end cap 26 configured to contact a commutator 34 on rotor 30. For example, one or more springs (not shown) may be used to urge brushes 28 toward commutator 30 to maintain contact between electric brushes 28 and commutator 34 even as electric brushes 28 may be worn down through wear and tear. In some embodiments, electric brushes 28 may be attached to an inner surface of outer shell 22.

Rotor 30 comprises an output shaft 31, an insulating sleeve 32 fixed to output shaft 31, and a rotor core 33 fixed to insulating sleeve 32, such that insulating sleeve 32 is sandwiched between output shaft 31 and rotor core 33. Thus, output shaft 31, insulating sleeve 32, and rotor core 33 are all fixed to each other and are able to rotate together. Output shaft 31 may be made of metal, and be rotably attached to outer shell 22 and/or end cap 26 of stator 20.

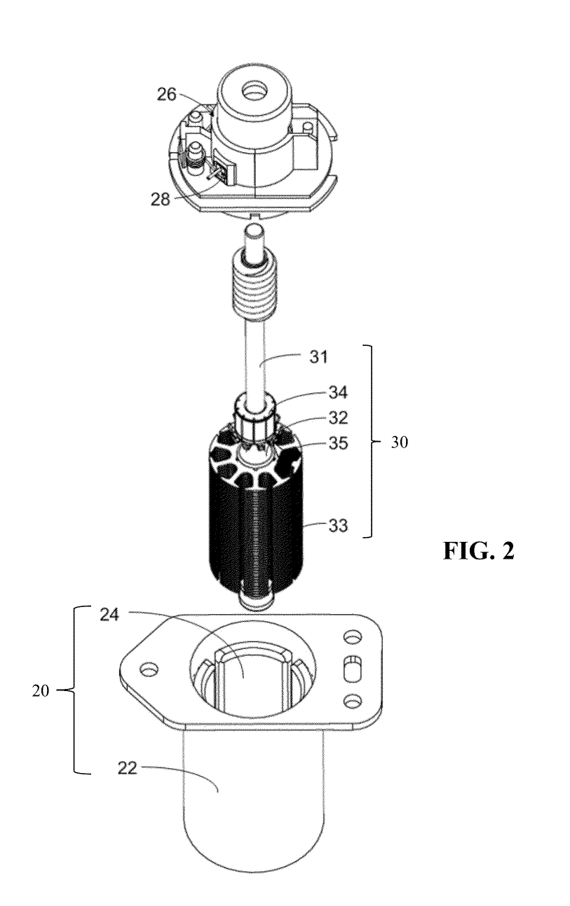

Commutator 34 is fixed to output shaft 31 and electrically connected to a plurality of winding loops 35 (one of which is illustrated in FIG. 2) on rotor core 33. In addition, commutator 34 is configured to be in sliding contact with electric brushes 28, such that electric brushes 28 are able to transfer electric current to winding loops 35 through commutator 34.

During operation of a typical DC electric motor such as, for example, motor 10, DC current travels through electric brushes 28 and commutator 34 to corresponding winding loops 35, which generate a magnetic field that interacts with the magnetic field of magnets 24, causing rotor 30 to rotate. As rotor 30 rotates, electric brushes 28 are in contact with different commuator bars of commutator 34.

During operation of motor 10, rotor 30 may rotate at speeds of thousands of revolutions per minute (rpm) or even higher. Consequently, the on and off switching of current within winding loops 35 may be very rapid, which generates high-frequency electromagnetic radiation. In many conventional DC electric motors, due to output shaft 31 and rotor core 33 being in direct contact, this high-frequency radiation is coupled to output shaft 31 and outer shell 22 through rotor core 33.

In accordance with an embodiment of the present invention, insulating sleeve 32 is disposed between output shaft 31 and rotor core 33, and rotor core 33 and output shaft 31 are not in direct contact. Rotor core 33, output shaft 31, and insulating sleeve 32 form a capacitor that may effectively prevent the high-frequency signal coupling to output shaft 31 through rotor core 33, reducing the amount of electromagnetic radiation emanating from output shaft 31 and improving the electromagnetic interference (EMI) characteristics of motor 10.

In addition, there is a gap between rotor core 33 and outer shell 22 of stator 20. Outer shell 22, rotor core 33, and the gap there between also form a capacitor. In some embodiments, outer shell 22 is grounded during operation of motor 10, providing for absorption of the high-frequency signal generated by winding coils 35.

The capacitance of a capacitor may be expressed with the following equation:

$$C = ɛ \frac{A}{d}$$

wherein ε corresponds to a dielectric constant, A corresponds to area of the capacitor plates, and d corresponds to the distance between the capacitor plates.

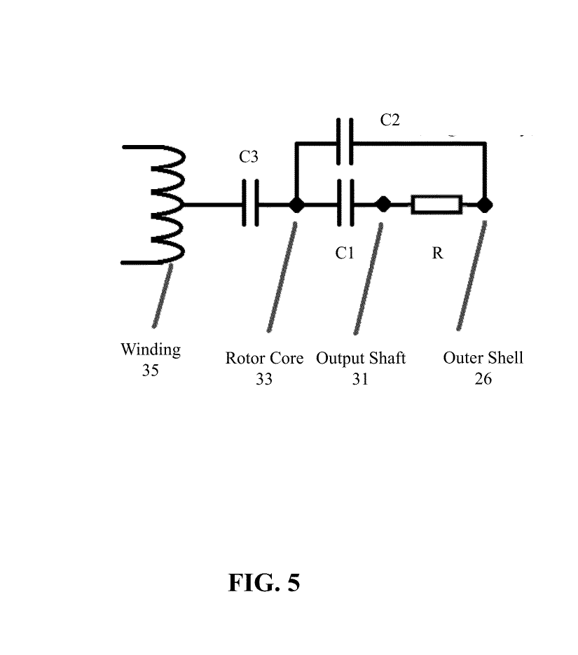

FIG. 5 is a schematic diagram illustrating impedances between different components of motor 10 from winding coils 35 to ground (outer shell 22). The capacitances of the and capacitors formed between rotor core 33 and rotor shaft 31 across insulating sleeve 32 and between rotor core 33 and outer shell 22 across the air gap are represented by C1 and C2, respectively. The capacitance between winding coils 35 and rotor core 33 is represented by C3, and a resistance between output shaft 31 and outer shell 22 is represented by R.

In general, the greater the total impedance between winding coils 35 and outer shell 22, and between winding coils 35 and output shaft 31, the better the reduction of high-frequency signals coupled to outer shell 22 and output shaft 31 will be. Because the value of R is generally small, the total impedance between rotor core 33 and outer shell 22 can be substantially determined by the impedance of C1 and C2 in parallel connection.

A lower value of C1 results in a lower capacitance and thus a higher impedance between winding coils 35 and output shaft 31. The higher impedance reduces the electromagnetic radiation that is able to be coupled to output shaft 31. The parameters of ε, A, and d may be configured in order to obtain a desired C1 value. For example, it is desirable for the thickness of insulating sleeve 32 (corresponding to d in the above equation) to be as large as possible. However, the thickness of insulating sleeve 32 is also constrained by limits of the size of motor 10. In some embodiments, the thickness of insulating sleeve 32 is configured to be at least 0.001 millimeter (mm). To configure the value of ε, different materials may be used for insulating sleeve 32. For example, in some embodiments, insulating sleeve 32 may be made of Teflon.

According to experimental results, when the ratio of C2 to C1 (i.e., C2/C1) is between 0.1 and 50, and preferably between 0.5 and 10, a good balance can be achieved between suppression or reduction of electromagnetic radiation, motor performance, and manufacturing costs. More preferably, having C2/C1 between 1 and 5 may allow for higher absorption of high-frequency signals coupled to outer shell 22, and further reduce the electromagnetic radiation of output shaft 31. This is because, in general, the smaller C1 is, the less the high-frequency radiation will be coupled to shaft 31; while the larger C2 is, the more the high-frequency radiation will be grounded by outer shell 22.

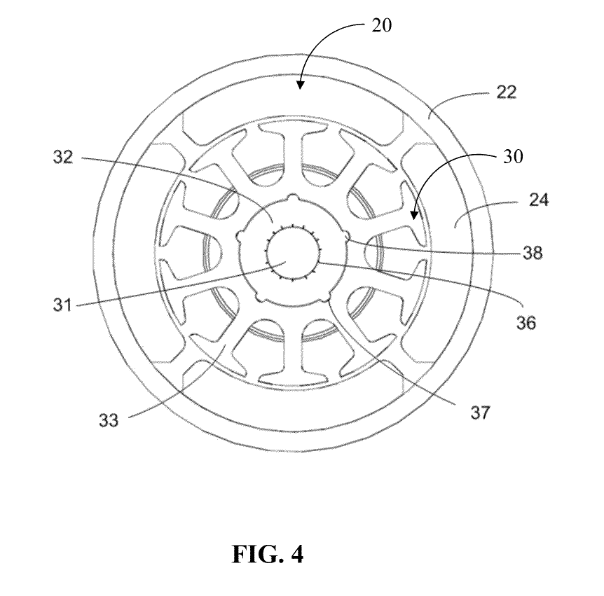

In some embodiments, as illustrated in FIG. 4, an outer surface of output shaft 31 comprises a plurality of protrusions 36 extending radially outwards. Insulating sleeve 32 may be formed over output shaft 31 through injection molding. Protrusions 36 serve to increase the contact surface area between output shaft 31 and insulating sleeve 32, thereby increasing the binding between output shaft 31 and insulating sleeve 32.

In addition, an inner surface of rotor core 33 facing insulating sleeve 32 may comprise a plurality of recesses 37 configured to accommodate protrusions 38 on an outer surface of insulating sleeve 32. The interface between recesses 37 and protrusions 38 may function to prevent rotor core 33 from rotating relative to insulating sleeve 32. In some embodiments, insulating sleeve 32 and rotor core 33 are connected through an interference fit, while insulating sleeve 32 and output shaft 31 may be connected by knurling.

It is understood that while embodiment illustrated in FIG. 4 shows output shaft 31 with a plurality of protrusions 36, in other embodiments, output shaft may instead have other structural features for interfacing with insulating sleeve 32, such as a plurality of recesses. Similarly, in other embodiments, an inner surface of rotor core 33 may contain a plurality of protrusions accommodated by a plurality of recesses on insulating sleeve 32, or other types of structural features.

In the foregoing specification, various aspects have been described with reference to specific embodiments thereof. It will, however, be evident that various modifications and changes may be made thereto without departing from the broader spirit and scope of various embodiments described herein. For example, the above-described systems or modules are described with reference to particular arrangements of components. Nonetheless, the ordering of or spatial relations among many of the described components may be changed without affecting the scope or operation or effectiveness of various embodiments described herein. In addition, although particular features have been shown and described, it will be understood that they are not intended to limit the scope of the claims or the scope of other embodiments, and it will be clear to those skilled in the art that various changes and modifications may be made without departing from the scope of various embodiments described herein. The specification and drawings are, accordingly, to be regarded in an illustrative or explanatory rather than restrictive sense. The described embodiments are thus intended to cover alternatives, modifications, and equivalents.

1. A direct current (DC) electric motor, comprising:
a stator comprising:
an outer shell,
a plurality of magnets fixed to the outer shell, and
a plurality of brushes disposed on the outer shell; and
a rotor configured to rotate within the stator, comprising:
an output shaft,
a rotor core,
a commutator fixed to the output shaft, wherein the commutator is in sliding contact with the plurality of brushes,
a plurality of winding coils wound on the rotor core and electrically connected to the commutator, and
an insulating sleeve disposed between the output shaft and the rotor core and fixedly attached to the output shaft and the rotor core.

2. The DC electric motor of claim 1, wherein:
the output shaft, the rotor core, and the insulating sleeve form a first capacitor having a first capacitance;
the rotor core and the outer shell form a second capacitor having a second capacitance equal to or greater than the first capacitance.

3. The DC electric motor of claim 2, wherein a ratio of the second capacitance to the first capacitance is between 1 and 5.

4. The DC electric motor of claim 1, wherein:
the output shaft, the rotor core, and the insulating sleeve form a first capacitor having a first capacitance;
the rotor core, the outer shell, an air gap between the rotor core and the outer shell form a second capacitor having a second capacitance; and
a ratio of the second capacitance to the first capacitance is between 0.1 and 50.

5. The DC electric motor of claim 4, wherein the ratio of the second capacitance to the first capacitance is between 0.5 and 10.

6. The DC electric motor of claim 1, wherein the insulating sleeve has a thickness of at least 0.001 millimeter.

7. The DC electric motor of claim 1, wherein an outer surface of the output shaft comprises a plurality of structural features configured to interface with the insulating sleeve.

8. The DC electric motor of claim 7, wherein the plurality of structural features comprise a plurality of protrusions.

9. The DC electric motor of claim 1, wherein the insulating sleeve is fixedly attached to the output shaft through injection molding.

10. The DC electric motor of claim 1, wherein:
the rotor core comprises a plurality of structural features on a radial inner surface thereof; and
the insulating sleeve comprises a plurality of structural features on a radial outer surface thereof mating with the plurality of structural features on the radial inner surface of the rotor core.

11. The DC electric motor of claim 10, wherein the plurality of structural features on the radial inner surface of the rotor core are recesses, and the plurality of structural features on the radial outer surface of the insulating sleeve are protrusions.

12. The DC electric motor of claim 10, wherein the plurality of structural features on the radial inner surface of the rotor core are protrusions, and the plurality of structural features on the radial outer surface of the insulating sleeve are recesses.

13. The DC electric motor of claim 1, wherein the outer shell is grounded during motor operation.

14. A method for assembling a DC electric motor, comprising:
molding an insulating sleeve on at least a portion of an outer surface of an output shaft of the DC electric motor; and
attaching a rotor core over an outer surface of the insulating sleeve, such that an inner surface of the rotor core is fixed to the outer surface of the insulating sleeve.

15. The method of claim 14, further comprising forming a plurality of structural features on an outer surface of the output shaft.

16. The method of claim 14, wherein molding an insulating sleeve on at least a portion of an outer surface of an output shaft the DC electric motor comprises fixedly attaching the insulating sleeve to the output shaft using injection molding.

17. The method of claim 14, further comprising forming a plurality of structural features on an inner surface of the rotor.

18. The method of claim 14, wherein molding an insulating sleeve on at least a portion of an outer surface of an output shaft of the DC electric motor includes selecting a thickness and a dielectric coefficient of the insulating sleeve to form a first capacitor having a first capacitance between the output shaft and the rotor core, a ratio of a second capacitance between the rotor core and an outer shell of the DC electric motor to the first capacitance is between 0.1 and 50.

19. The method of claim 18, wherein the ratio of the second capacitance to the first capacitance is between 0.5 and 10.

20. The method of claim 18, wherein the ratio of the second capacitance to the first capacitance is between 1 and 5.
